(19) United States
(12) Patent Application Publication
(10) Pub. No.: US 2016/0004313 A1
(43) Pub. Date: Jan. 7, 2016

(54) HAPTIC SYSTEM, METHOD FOR CONTROLLING THE SAME, AND GAME SYSTEM

(71) Applicant: GWANGJU INSTITUTE OF SCIENCE AND TECHNOLOGY, Gwangju (KR)

(72) Inventors: Je-Ha RYU, Gwangju (KR); Chang-Gyu LEE, Gwangju (KR); Dae-Hyeon JEONG, Gwangju (KR)

(21) Appl. No.: 14/791,264

(22) Filed: Jul. 3, 2015

(30) Foreign Application Priority Data
Jul. 3, 2014 (KR) 10-2014-0082877

(51) Int. Cl. G06F 3/01

(52) U.S. Cl. CPC G06F 3/016

(57) ABSTRACT

A haptic system includes: at least one bio-signal measuring unit configured to measure a bio-signal from a user in response to visual information; at least one haptic information providing unit equipped on the user and configured to provide haptic information; and a controller configured to operate the haptic information providing unit when there is a change in the bio-signal.

The haptic device does not require calibration, so that a user can use the haptic system conveniently in any environment. In addition, the user's location and action can be determined accurately.

### BACKGROUND

1. Technical Field

The present disclosure relates to a haptic system, a method for controlling the same and a game system. More specifically, the present disclosure relates to a haptic system that allows a user to enjoy it more conveniently, a method for controlling the same, and a game system.

2. Description of the Related Art

A haptic system refers to a device capable of transferring information to a user using a tactile feedback, etc. A typical application of the haptic system is a personal terminal which applies vibration, etc., to a user by sensing a touched status when the user touches the screen with her/his finger.

In addition to such a typical application of the haptic system, there has been proposed a haptic system that senses an action of a person's body and applies vibration, pressure, etc., when the person comes in contact with a virtual object or an actual object at a remote location (hereinafter collectively referred to as an object). The haptic system may be employed in remote medical service, virtual games, repair machine, etc. For such applications of the haptic system, it is essential to locate a user in a three-dimensional space by sensing the user's action.

As an existing technology to determine a user's action, there is known a method of sensing the user's action by sensors or determining the user's location and movement by geometrically analyzing recorded images. As an example, there are motion tracking techniques under a variety of trade marks.

According to the motion tracking techniques, a user's action is captured in multiple directions as moving images, and the images are analyzed to determine whether the user comes in contact with an object. To this end, coordinates of the environment where the user is located and coordinates of the environment where the object is located have to be calibrated with respect to each other and then a user is able to operate a haptic system. Such calibration has to be performed whenever the environment of the haptic system is changed, making the use of the haptic system complicated and difficult. In addition, even after calibration, additional complicated calculation processes such as image rendering have to be performed. Accordingly, it is difficult to accurately determine whether the user comes in contact with the object.

If additional sensors are used, it is difficult to accurately determine whether a contact is made, as well as high cost of the sensors. Further, an action can be determined only in a limited range.

### SUMMARY

The present disclosure has been made in an effort to provide a haptic system that is inexpensive, eliminates difficulty in calibration between a user environment and an object environment, is capable of accurately determine whether a user comes in contact with an object, and has no limitation on a user's mobility. The present disclosure also provides a method for controlling the haptic system, and a game system.

According to an aspect of the present disclosure, there is provided a haptic system including: at least one bio-signal measuring unit configured to measure a bio-signal from a user in response to visual information; at least one haptic information providing unit equipped on the user and configured to provide haptic information; and a controller configured to operate the haptic information providing unit when there is a change in the bio-signal.

The haptic system may further include: a visual information displaying unit configured to provide the visual information. The visual information displaying unit may be controlled by the controller.

The bio-signal may include an electromyography (EMG) signal or a brainwave signal.

The haptic system may be most advantageous in game system applications.

According to another aspect of the present disclosure, there is provided a method for controlling a haptic system, the method including: measuring a bio-signal in response to visual information; and driving a haptic device upon sensing a change in the bio-signal. The bio-signal comprises at least one of an electromyography (EMG) signal and a brainwave signal.

The driving the haptic device may include driving the haptic device only when the change in the bio-signal corresponds to the visual information. The driving the haptic device may include determining whether the bio-signal is measured in a predetermined pattern to drive the haptic device based on the pattern. By doing so, it is possible to provide a user with a variety of haptic information pieces and provide better user satisfaction.

As set forth above, according to the present disclosure, the haptic system does not require calibration, so that a user can use the haptic system conveniently in any environment.

In addition, the user's action can be determined accurately.

Further, complicated calculation processes such as image processing is not required, so that the haptic system can be operated faster.

Moreover, the haptic system can be implemented at low cost, and thus can be used for personal use such as game applications, providing a variety of applications.

Moreover, the haptic system does not have a particular range in which it can determine a user's movement and actions, and thus the system can be operated without spatial limitation.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a diagram of a haptic system according to a first embodiment in use;

FIG. 2 is a flowchart for illustrating a method for controlling the haptic system according to the first embodiment;

FIG. 3 is a diagram of a haptic system according to a second embodiment in use;

FIG. 4 is a flowchart for illustrating a method for controlling the haptic system according to the second embodiment;

FIG. 5 is a diagram of the haptic system according to the third embodiment in use; and

FIG. 6 is a flowchart for illustrating a method for controlling the haptic system according to the fourth embodiment.

### DETAILED DESCRIPTION

Embodiments of the present disclosure will now be described in detail with reference to the accompanying drawings. However, it should be noted that the scope of the present disclosure is not limited to the embodiments set forth herein; and those skilled in the art, having benefit of this detailed description, will appreciate that other equivalent embodiments are possible by adding, modifying and eliminating elements, which are also construed as falling within the scope of the present disclosure.

### First Embodiment

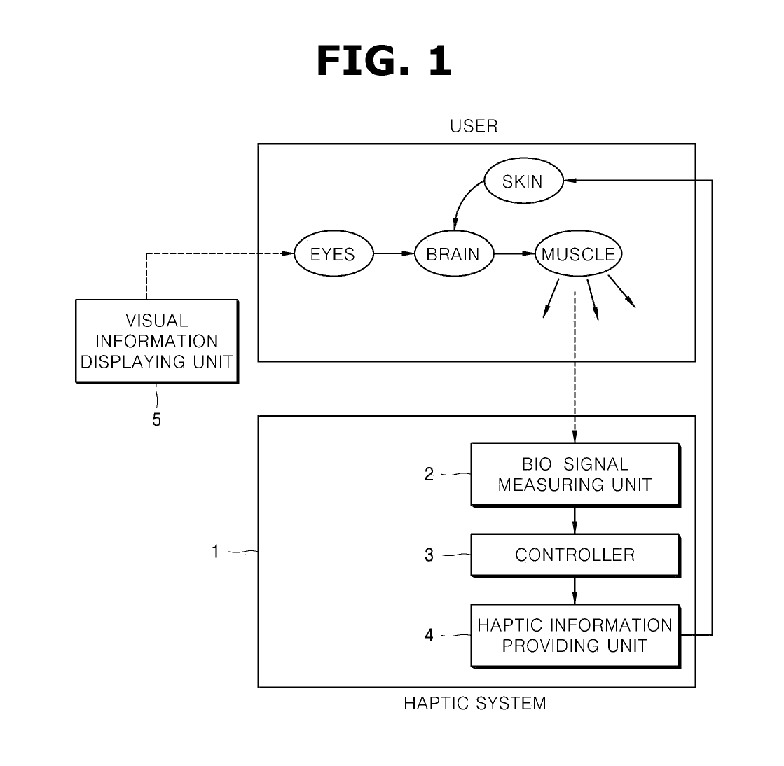

FIG. 1 is a diagram of a haptic system according to a first embodiment in use.

In FIG. 1, a haptic system 1, a visual information displaying unit 5, and a user are shown. The haptic system 1 includes a bio-signal measuring unit 2 for measuring a bio-signal from the user to learn bio-signal information, and a haptic information providing unit 4 for providing the user with haptic information under the control of the controller 3. The visual information displaying unit 5 provides the user with visual information. The user perceives visual information displayed by the visual information displaying unit 5 to make a decision based on the visual information, and takes an action using muscles accordingly.

The visual information displaying unit 5 may be an ordinary display, a three-dimensional display such as a holographic display, 2.5 D display, etc. The bio-signal measuring unit 2 may be, for example, an electromyograph that is equipped on the body of a user to measure electromyography (EMG) signals generated when muscles are contracted and expanded. The haptic information providing unit 4 may be, for example, a device that is equipped on a skin of a user, e.g., a palm of the user for applying pressure thereon.

The operation of the haptic system will be described in detail below.

When the visual information displaying unit 5 provides image information, the user perceives it with her/his eyes and makes a decision with her/his brain whether to contract or expand muscles. At this time, muscles generate EMG signals, which may be measured by the bio-signal measuring unit 2 equipped on the user. The information measured by the bio-signal measuring unit 2 is delivered to the controller 3. The controller 3 utilizes a change in the EMG signals as a trigger signal to operate the haptic information providing unit 4 and provides the user with haptic information.

A more specific operation example will be described.

An example will be described with respect to a whack-a-mole game, in which a user hits moles popping up from their holes at random with her/his palm. On the visual information displaying unit 5, moving pictures are displayed showing that moles pop up at random and go back soon. The user hits a mole with her/his palm when it pops up in the pictures. When the user hits a mole with her/his palm, muscles around the elbow or wrist are contracted and expanded. Sensors of the electromyograph are attached around the muscles as the bio-signal measuring unit 2. The bio-signal measuring unit 2 measures EMG signals to sense that the user uses the muscles, and delivers the EMG signals to the controller 3. Upon sensing the muscles being used, the controller 3 receives it as a trigger signal and operates the haptic information providing unit 4 equipped on the user's palm either immediately or after a time interval. The haptic information providing unit 4 applies pressure or impact on the palm, so that the user feels as if she/he hit a mole.

The visual information displaying unit 5 may provide 2D images, as well as 2.5 D or 3D images. In the latter cases, EMG signals from at least two muscles at different locations of the users' body may be measured and utilized. For example, it is possible to learn what action the user takes in which direction in a three-dimensional space. Additionally, at least two haptic information providing units 4 may be provided so that a variety of haptic information pieces may be applied to a user as the user takes actions.

The above-described haptic system may be employed by a game system such as a whack-a-mole game.

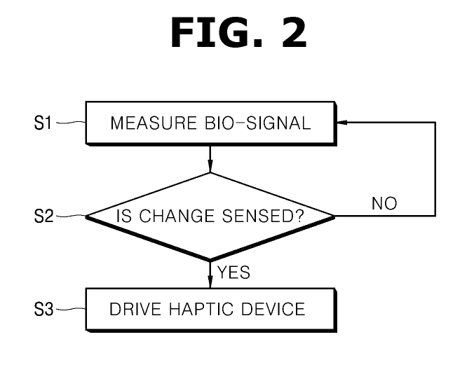

FIG. 2 is a flowchart for illustrating a method for controlling the haptic system according to the first embodiment.

Referring to FIG. 2, the haptic system measures a bio-signal from a user (step S1). If it is determined that there is a change in the measured bio-signal (step S2), a haptic device may be driven to provide the user with haptic information (step S3). The bio-signal is preferably an EMG signal.

According to the first embodiment, calibration is not necessary at all, so that the haptic system may be used in any environment without performing calibration. In addition, since a user's action is sensed only by sensing EMG signals, complicated operations such as image processing are not required, so that the haptic system can be operated faster. Moreover, the system requires an electromyograph only, and thus may be implemented at low cost. Further, the system has a variety of applications including as game applications. Moreover, the haptic system can be operated by simply measuring EMG signals, and thus the haptic system does not have a particular range in which it can determine a user's movement and actions. Accordingly, the system can be operated without spatial limitation.

### Second Embodiment

A second embodiment of the present disclosure is identical to the first embodiment except for that the visual information displaying unit 5 is incorporated in the haptic system. The elements described above with respect to the first embodiment will not be described again.

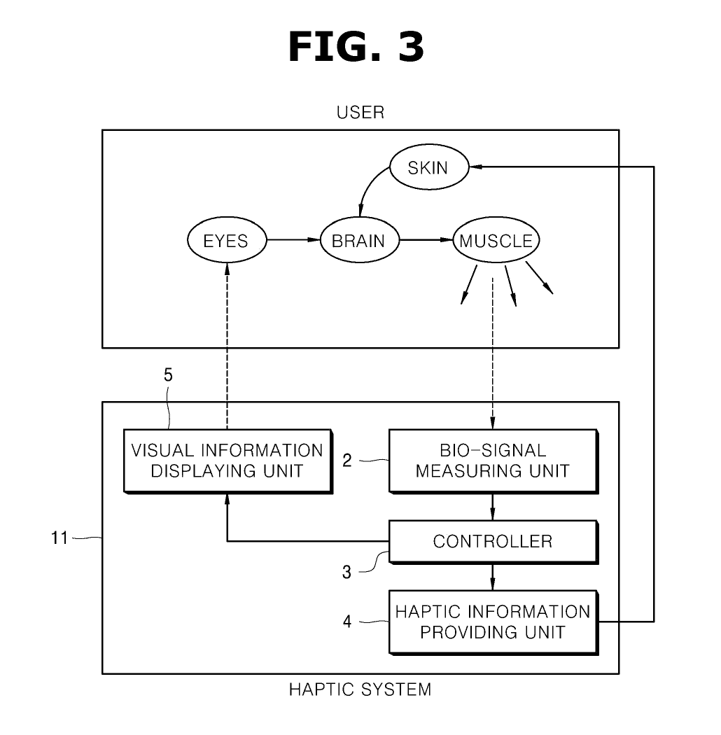

FIG. 3 is a diagram of the haptic system according to the second embodiment in use.

The haptic system 11 according to the second embodiment includes a visual information displaying unit 5, a bio-signal measuring unit 2, and a controller 3 and a haptic information providing unit 4.

The visual information displaying unit 5 may be an ordinary display, a three-dimensional display such as a holographic display, 2.5 D display, etc. The visual information displaying unit 5 is operated under the control of the controller 3. The bio-signal measuring unit 2 may be, for example, an electromyograph that is equipped on the body of a user to measure electromyography (EMG) signals generated when muscles are contracted and expanded. The haptic information providing unit 4 may be a device that is equipped on a palm of a user for applying pressure thereon.

The operation of the haptic system will be described in detail below.

If the visual information displaying unit 5 provides image information under the control of the controller 3, the user perceives it with her/his eyes and makes a decision with her/his brain whether to contract or expand muscles. At this time, muscles generate EMG signals, which may be measured by the bio-signal measuring unit 2 equipped on the user. The information measured by the bio-signal measuring unit 2 is delivered to the controller 3. The controller 3 determines whether the generated EMG signals are synchronized with the image displayed by the visual information displaying unit 5, and then operates the haptic information providing unit 4 in a variety of manners to provide the user with haptic information.

A more specific operation example will be described.

The user plays a game displayed by the visual information displaying unit 5, in which she/he hits moles popping up from their holes at random with her/his palm under the control of the controller 3. On the visual information displaying unit 5, moving pictures are displayed showing that moles pop up at random and go back soon. The user hits a mole with her/his palm when it pops up in the pictures. When the user hits a mole with her/his palm, muscles around the elbow or wrist are contracted and expanded. Sensors of the electromyograph are attached around the muscles as the bio-signal measuring unit 2. The bio-signal measuring unit 2 measures a change in EMG signals to sense that the user uses the muscles, and delivers the EMG signals to the controller 3. The controller 3 determines whether the timing at which a mole pops up in the image displayed by the visual information displaying unit 5 is synchronized with the timing at which a change is made in the EMG signals. For example, if it is determined that the timing at which a mole pops up in the image is synchronized with the timing at which a change is made in the EMG signals, it is determined that the user has hit the mole timely. Then, the haptic information providing unit 4 equipped on the user's palm is operated such that the user feels as if she/he has hit the mole timely. If it is determined that the timings are not synchronized to each other, the haptic information providing unit 4 may not be operated. It is to be noted that the determining whether the timings are synchronized to each other may take into account some time delays caused by the user's neutron system, brain, etc.

In a 3D or 2.5 D environment, the user's actions such as stretching her/his arm forward, holding with fingers, etc., may be measured by the bio-signal measuring unit 2 equipped around muscles for taking that action, and haptic information may be provided by the haptic information providing unit 4 equipped on a skin of the user at the corresponding part.

It will be understood that the second embodiment may also be employed by game systems such as a whack-a-mole game.

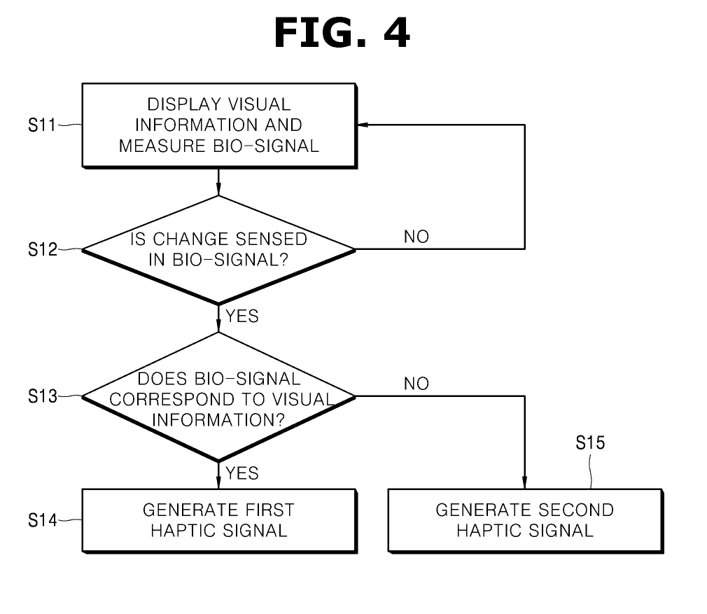

FIG. 4 is a flowchart for illustrating a method for controlling the haptic system according to the second embodiment.

Referring to FIG. 4, a bio-signal is measured from a user while visual information is being displayed (step S11). If a change is sensed in the measured bio-signal (step S12), it is determined whether the change in the bio-signal corresponds to the visual information (step S13). If the change in the bio-signal corresponds to the visual information, i.e., the temporal synchronization level between the visual information and the bio-signal is above a predetermined level (if there is substantially no time difference between the visual information and the bio-signal), a first haptic signal may be generated (step S14). If the temporal synchronization level between the visual information and the bio-signal is below the predetermined level (if there is a time difference between the visual information and the change in the bio-signal), a second haptic signal may be generated (step S15). The bio-signal is preferably an EMG signal. The first haptic signal may apply impact or pressure to the user. The second haptic signal may apply weak impact or pressure to the user or may apply no haptic signal. In some embodiments, the second haptic signal may apply a strength-adjustable haptic signal, thereby providing better satisfaction.

According to the second embodiment, it is possible to make a game more exciting and provide better user satisfaction. In addition, it is possible to figure out the user's location and action based on a synchronization level with the displayed 3D image information.

### Third Embodiment

A third embodiment of the present disclosure is identical to the first and second embodiments except for that a bio-signal measuring unit is measuring a user's brainwave instead of electromyogram. The elements described above with respect to the first and second embodiments will not be described again. It is easy to understand how this embodiment is applied to the first embodiment since it can be applied by simply replacing the electromyogram with the brainwave. Accordingly, the description will be made more detail how this embodiment is applied to the second embodiment.

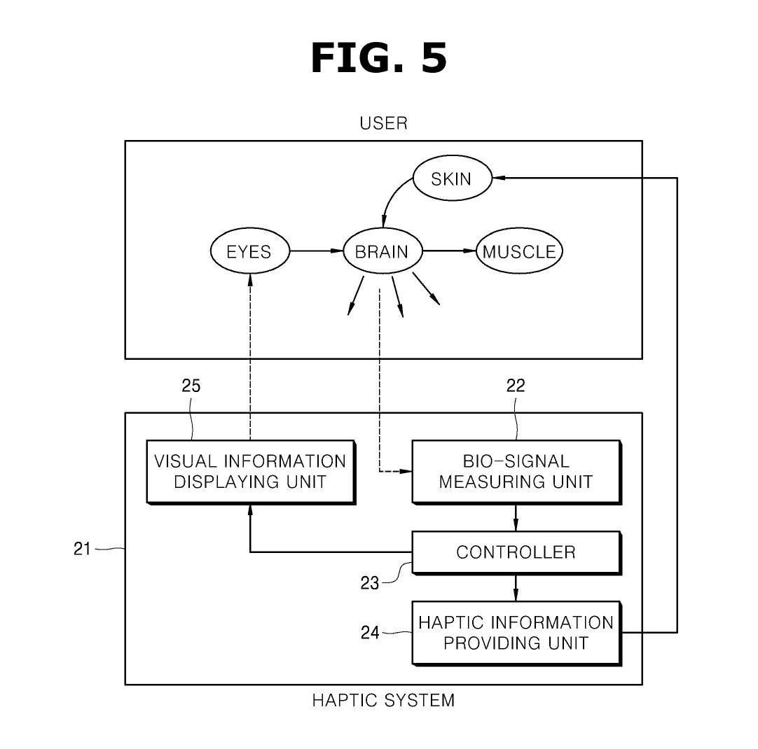

FIG. 5 is a diagram of the haptic system according to the third embodiment in use.

The haptic system 11 according to the third embodiment includes a visual information displaying unit 5, a bio-signal measuring unit 2, and a controller 3 and a haptic information providing unit 4.

The visual information displaying unit 5 may be an ordinary display, a three-dimensional display such as a holographic display, 2.5 D display, etc. The visual information displaying unit 5 is operated under the control of the controller 3. As the bio-signal measuring unit, an instrument equipped on a user's head for measuring a brainwave such as electroencephalogram (EEG) may be used. The haptic information providing unit 4 may be a device that is equipped on a palm of a user for applying pressure thereon.

The operation of the haptic system will be described in detail below.

If the visual information displaying unit 5 provides image information under the control of the controller 3, the user perceives it with her/his eyes and makes a decision with her/his brain whether to contract or expand muscles. A change in the brainwave is made when the muscles are contracted or expanded. In addition, a change in the brainwave may be caused by a strong visual stimulus. The brainwave may be measured by the bio-signal measuring unit 2 equipped on the user's head. The change in the brainwave measured by the bio-signal measuring unit 2 is delivered to the controller 3. The controller 3 determines whether the change in the brainwave are synchronized with the image displayed by the visual information displaying unit, and then operates the haptic information providing unit 4 to provide the user with haptic information.

A more specific operation example will be described.

The user plays a game displayed by the visual information displaying unit 5, in which she/he hits moles popping up from their holes at random with her/his palm under the control of the controller 3. On the visual information displaying unit 5, moving pictures are displayed showing that moles pop up at random and go back soon. The user hits a mole with her/his palm when it pops up in the pictures. When the user takes an action of hitting a mole with her/his palm, a brainwave is generated which is related to an action of making a decision that a mole has popped up and an action of contracting and expanding muscles around the elbow or wrist. The change in the brainwave is measured by the bio-signal measuring unit 2 and is delivered to the controller 3. The controller 3 determines whether the timing at which a mole pops up in the image displayed by the visual information displaying unit 5 is synchronized with the timing at which a change is made in the brainwave. For example, if it is determined that the timing at which a mole pops up in the image is synchronized with the timing at which a change is made in the brainwave, it is determined that the user has hit the mole timely. Then, the haptic information providing unit 4 equipped on the user's palm is operated such that the user feels as if she/he has hit the mole timely. It is to be understood that if it is determined that the timings are not synchronized to each other or if there is a large time difference, the haptic information providing unit 4 may not be operated. It is to be noted that the determining whether the timings are synchronized to each other may take into account some time delays caused by the user's neutron system, brain, etc.

It will be understood that the third embodiment may also be employed by game systems such as a whack-a-mole game.

The third embodiment may be used when the bio-signal measuring unit and the haptic information providing unit are located at the same place or adjacent places, while exhibiting the same effects as the first and second embodiments.

### Fourth Embodiment

A fourth embodiment of the present disclosure uses a change in a brainwave together with a change in electromyogram. Descriptions will be described focusing on differences from the above-described embodiments.

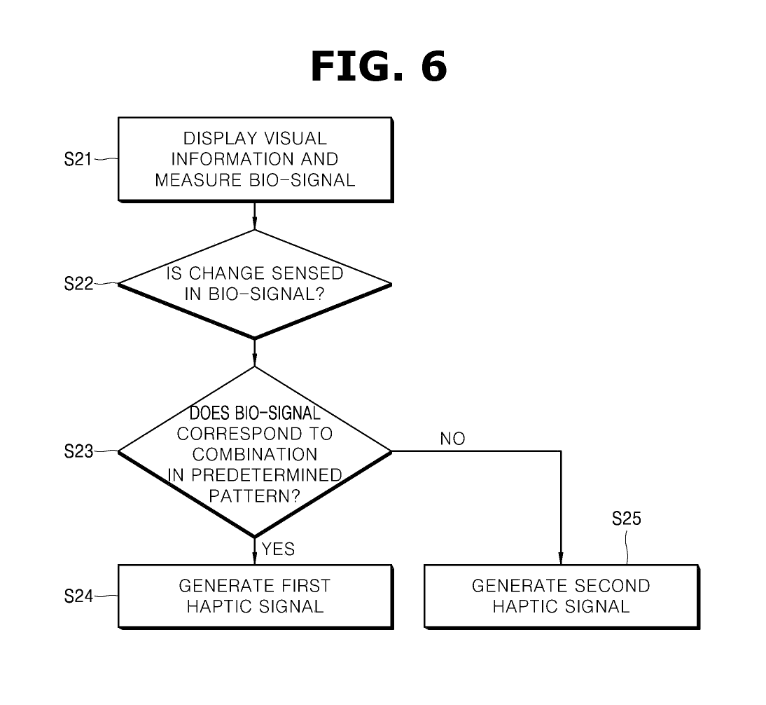

FIG. 6 is a flowchart for illustrating a method for controlling the haptic system according to the fourth embodiment.

Referring to FIG. 6, bio-signals are measured from a user while visual information is displayed (step S21). The bio-signals are obtained by measuring a change in the brainwave and a change in the electromyogram. If a change is sensed in the measured bio-signals (step S22), it is determined whether the bio-signals are measured in a certain pattern. For example, a brainwave for moving a muscle appears slightly earlier than the muscle actually moves. Accordingly, by measuring a time period after a change in the brainwave is made until a change in the electromyogram is made, it is possible to more accurately and precisely check a change made by a user in response to a particular visual information. As another example, when electromyogram of a first location muscle is changed and then electromyogram of a second location muscle is changed as a user takes an action, it is possible to accurately figure out what action the user takes and which visual information the action corresponds to. For example, when the user hits a mole, muscles around the elbow may be first moved, and then muscles around the wrist may be moved. When the user takes the opposite action, the muscles are likely to move in the reverse order. By employing the pattern of the bio-signals, the number of cases used for figuring out which visual information the user has responded to can be drastically increased.

Subsequently, if the change in the bio-signal corresponds to the visual information, i.e., the temporal synchronization between the visual information and the bio-signal is above a predetermined level, a first haptic signal corresponding to the bio-signal may be generated (step S24). If the bio-signal does not correspond to the visual information, a second haptic signal may be generated (step S25). The number of the haptic signals are not limited to two. More haptic signals may be provided as the user takes more complicated actions.

According to the fourth embodiment, by sensing a variety of bio-signals from a user for visual information, and applying haptic signals accordingly, it is possible to further increase the user satisfaction. In addition, it is possible to more accurately determine which visual information a bio-signal corresponds to, thereby accurately controlling the haptic system.

What is claimed is:

1. A haptic system comprising:
at least one bio-signal measuring unit configured to measure a bio-signal from a user in response to visual information;
at least one haptic information providing unit equipped on the user and configured to provide haptic information; and
a controller configured to operate the haptic information providing unit when there is a change in the bio-signal.

2. The haptic system of claim 1, further comprising:
a visual information displaying unit configured to provide the visual information, wherein the visual information displaying unit is controlled by the controller.

3. The haptic system of claim 2, wherein the visual information has a sense of volume.

4. The haptic system of claim 1, wherein the bio-signal comprises at least one electromyography (EMG) signal.

5. The haptic system of claim 1, wherein the bio-signal comprises at least one brainwave signal.

6. The haptic system of claim 1, wherein the bio-signal comprises at least one brainwave signal and at least one EMG signal.

7. A method for controlling a haptic system, the method comprising:
measuring a bio-signal in response to visual information; and
driving a haptic device upon sensing a change in the bio-signal, wherein the bio-signal comprises at least one of an electromyography (EMG) signal and a brainwave signal.

8. The method of claim 7, wherein the driving the haptic device comprises driving the haptic device only when the change in the bio-signal corresponds to the visual information.

9. The method of claim 7, wherein the driving the haptic device comprises determining whether the bio-signal is measured in a predetermined pattern to drive the haptic device based on the pattern.
